(19) United States
(12) Patent Application Publication
(10) Pub. No.: US 2024/0018827 A1
(43) Pub. Date: Jan. 18, 2024

(54) WINDOW SHADE ADJUSTMENT DEVICE

(71) Applicant: CHING FENG HOME FASHIONS CO., LTD., Changhua County (TW)

(72) Inventor: WEN YING LIANG, Changhua County (TW)

(21) Appl. No.: 17/898,325

(22) Filed: Aug. 29, 2022

(30) Foreign Application Priority Data
Jul. 15, 2022 (TW) 111126626

(51) Int. Cl. E06B 9/44

(52) U.S. Cl. CPC E06B 9/44

(57) ABSTRACT

A window shade adjustment device includes a top rail having two covers on two ends thereof, a housing located between the two covers and having a scrolling part located there. A shade is connected to the top rail and lifted or lowered along with rotation of the housing. Two end caps are respectively engaged with the two ends of the housing. Each end cap includes a tubular portion and a flange which extends radially therefrom. The flanges each are a ring-shaped part, and the thick of the flange is reduced from a center of the flange toward the periphery of the flange so as to form a ramp face that faces the housing. Multiple protrusions protrude axially from the ramp face of each of the flanges. When the shade moves upward and tilt, the shade moves along the ramp face and the protrusions which guide the shade not to tilt.

### BACKGROUND OF THE INVENTION

### 1. Fields of the Invention

The present invention relates to an adjustment device, and more particularly, to a window shade adjustment device to automatically adjust the window shade to maintain straight upward when the shade is scrolled upward.

### 2. Descriptions of Related Art

As shown in FIGS. 1 and 2, a conventional window shade is illustrated, and generally comprises a top rail 1, an elongate housing 3 located between two covers 2 that are located at two ends of the top rail 1, a scrolling part 4 received in the housing 3, a shade 4 wrapped around the housing 3 and being controlled by the scrolling part 4, and a bottom rail 6 connected to the lower end of the shade 4. When the users pull the bottom rail 6, the scrolling part 4 is activated and the housing 3 rotates so as to lift or lower the shade 5.

However, when the shade 5 moves upward, the shade 5 may be tilt toward one side of the window due to other forces applied to the shade 5. The shade 5 may be tilt and stocked as shown in FIG. 2.

The present invention intends to provide a window shade adjustment device to automatically adjust the window shade to maintain straight upward to eliminate the shortcomings mentioned above.

### SUMMARY OF THE INVENTION

The present invention relates to a window shade adjustment device and comprises a top rail with two covers connected to two ends thereof. A housing is located between the two cover and is a hollow tube. A scrolling part is located in the housing. The top rail includes a slit formed axially along one side thereof. A shade has an insertion on the top edge thereof, and the insertion is inserted into the slit. The shade is lifted or lowered along with rotation of the housing. A bottom rail is connected to the lower end of the shade.

Two end caps are respectively engaged with the two ends of the housing. Each end cap is located between the cover corresponding thereto and the housing. Each end cap includes a tubular portion and a flange which extends radially outward from the tubular portion. The tubular portion of each end cap is inserted into the housing. The end caps is co-rotated with the housing.

Each of the flanges is a ring-shaped part, and the thickness of each of the flanges is reduced from a center of the flange toward the periphery of the flange so as to form a ramp face that faces the housing. Multiple protrusions protrude axially from the ramp face of each of the flanges and toward the housing. The protrusions are located circularly along the flanges. When the shade moves upward and tilt, the shade moves along the ramp face and the protrusions which guide the shade not to tilt.

The primary object of the present invention is to provide a window shade adjustment device that includes two end caps on two ends of the housing, and each end cap includes a tubular portion and a flange which protrudes radially from the tubular portion. Each flange includes a ramp face that is tapered relative to a vertical plane. Multiple protrusions extend axially from the ramp face. When the shade moves upward and tilt, the shade moves along the ramp face and the protrusions which guide the shade not to tilt.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional window shade;

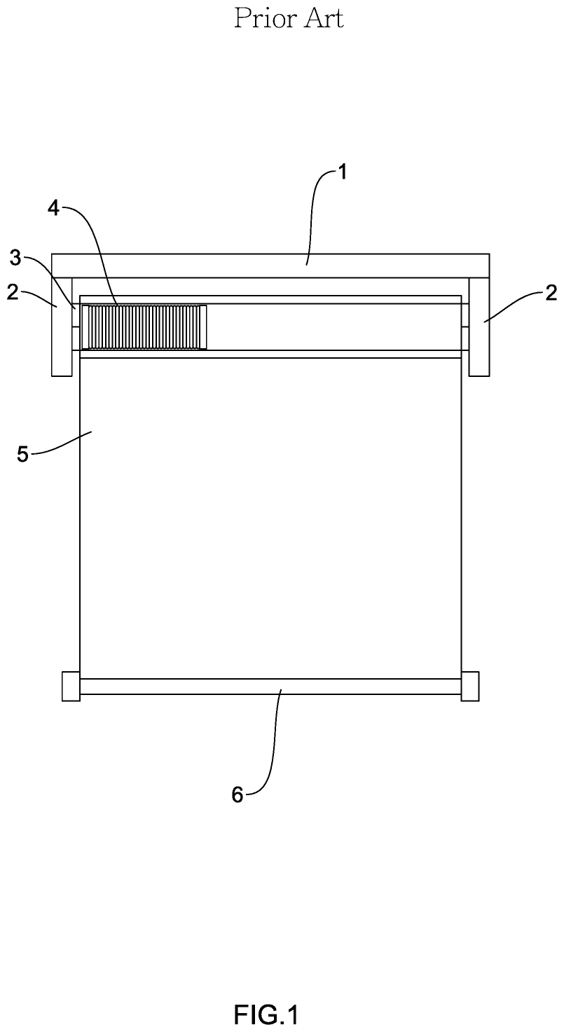

FIG. 2 shows that the shade tilts during being lifted;

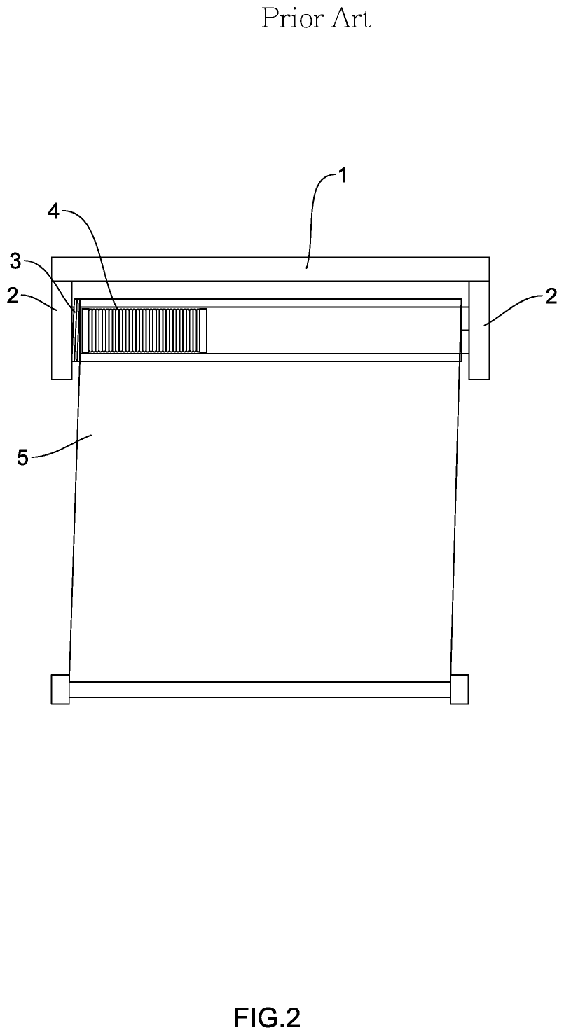

FIG. 3 shows a window shade with the window shade adjustment device of the present invention;

FIG. 4 is an exploded view of the window shade adjustment device of the present invention;

FIG. 5 shows the end cap of the window shade adjustment device of the present invention;

FIG. 6 is a cross sectional view, taken along line A-A in FIG. 5;

FIG. 7 shows that the shade tilts and moves over the ramp face and the protrusion of the window shade adjustment device of the present invention, and

FIG. 8 shows that the shade is guided and corrected by the ramp face and the protrusion of the window shade adjustment device of the present invention.

### DETAILED DESCRIPTION OF THE PREFERRED EMBODIMENT

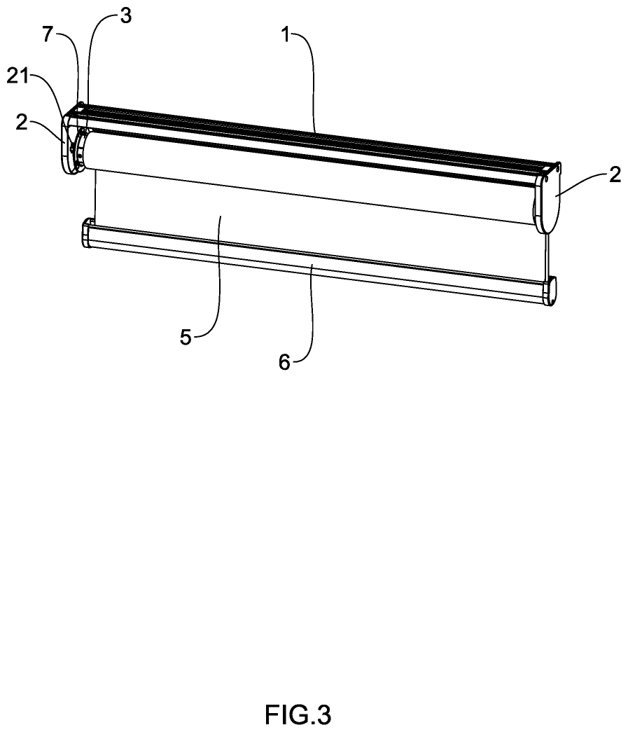

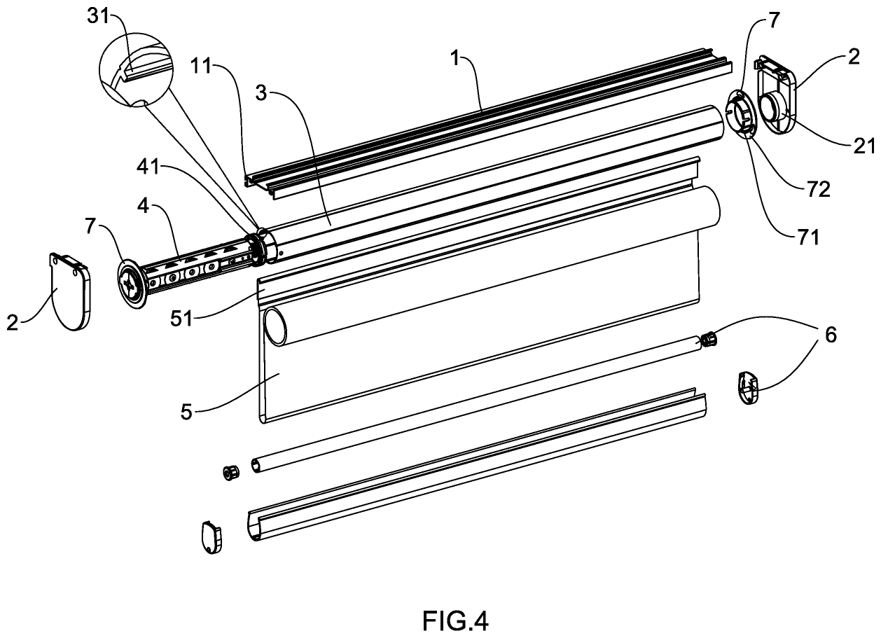

Referring to FIGS. 3 and 4, the window shade adjustment device of the present invention comprises a top rail 1, two covers 2, a housing 3, a scrolling part 4, a shade 5, a bottom rail 6 and two end caps 7.

The two cover 2 are connected to two ends of the top rail 1, and each cover 2 has a tube 21 extending therefrom. The housing 3 is located between the two cover 2 and is a hollow tube. The housing 3 is located between the two tubes 21 of the two covers 2, and the housing 3 is freely rotated relative to the two covers 2. The housing 3 includes a ridge 31 so as to be connected to the scrolling part 4 which is located in the housing 3. The scrolling part 4 includes engaging members 41 which are engaged with the ridge 31.

The top rail 1 has a slit 11 formed axially along one side thereof. The shade 5 has an insertion 51 on the top edge thereof, and the insertion 51 is inserted into the slit 11. When the housing 3 is rotated, the scrolling part 4 is co-rotated with the housing 3 by the engagement of the engaging members 41 and the ridge 31, so as to control the movement of the shade 5. It is noted that the scrolling part 4 can be a torsion spring or a gear box.

The insertion 51 of the shade 5 is inserted into the slit 11 of the top rail 1 so that the shade is lifted or lowered when the housing 3 is rotated. A bottom rail 6 is connected to the lower end of the shade 5, so that the users may operate the bottom rail 6 to lift or lower the shade 5.

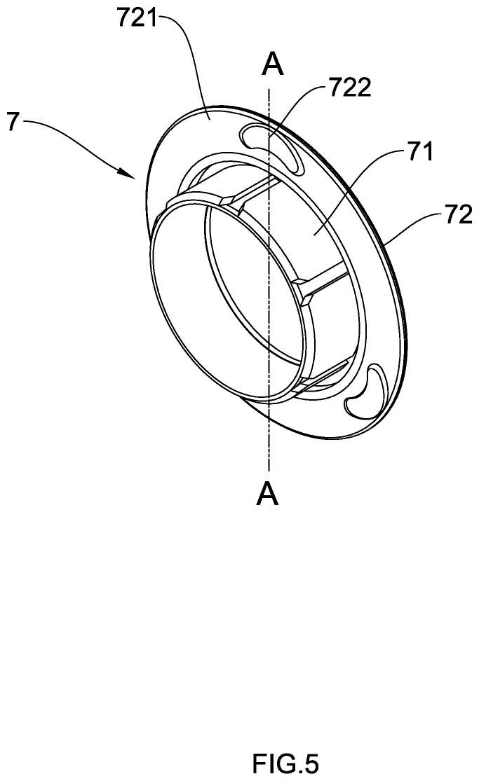

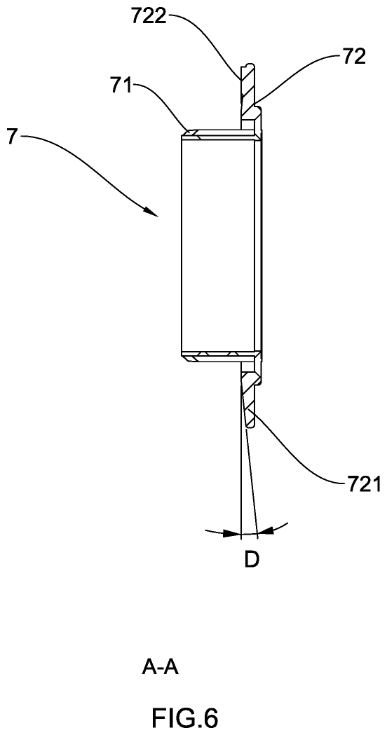

As shown in FIGS. 5 and 6, two end caps 7 are respectively engaged with the two ends of the housing 3, wherein each end cap 7 is located between the cover 2 corresponding thereto and the housing 3. Each end cap 7 includes a tubular portion 71 and a flange 72 which extends radially outward from the tubular portion 71. The tubular portion 71 of each end cap 7 is inserted into the housing 3. The end caps 7 are co-rotated with the housing 3. Each of the flanges 72 is a ring-shaped part, and the thickness of each of the flanges 72 being reduced from the center of the flange 72 toward the periphery of the flange 72 so as to form a ramp face 721 that faces the housing 3. Preferably, as shown in FIG. 6, the angle “D” between the ramp face 721 and a vertical line is 2 to 8 degrees. Multiple protrusions 722 protrude axially from the ramp face 721 of each of the flanges 72 and toward the housing 3. The protrusions 722 are crescent-shaped and located circularly along the flanges 72.

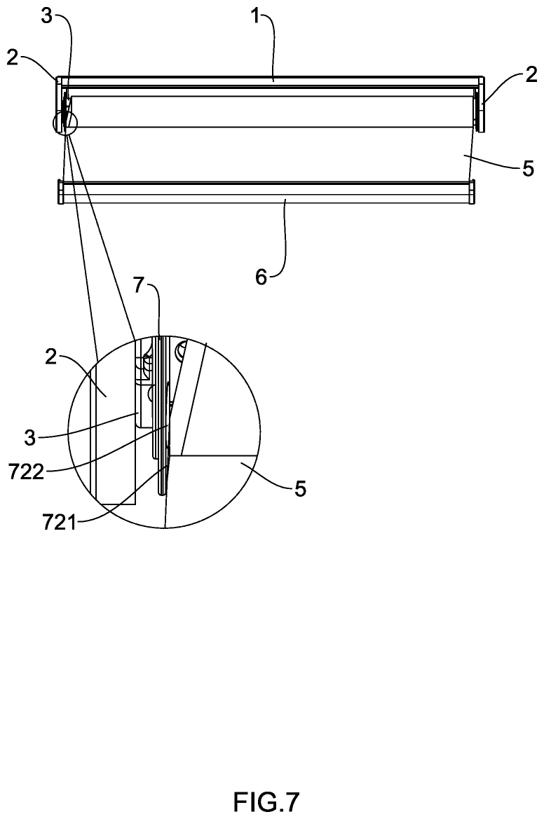

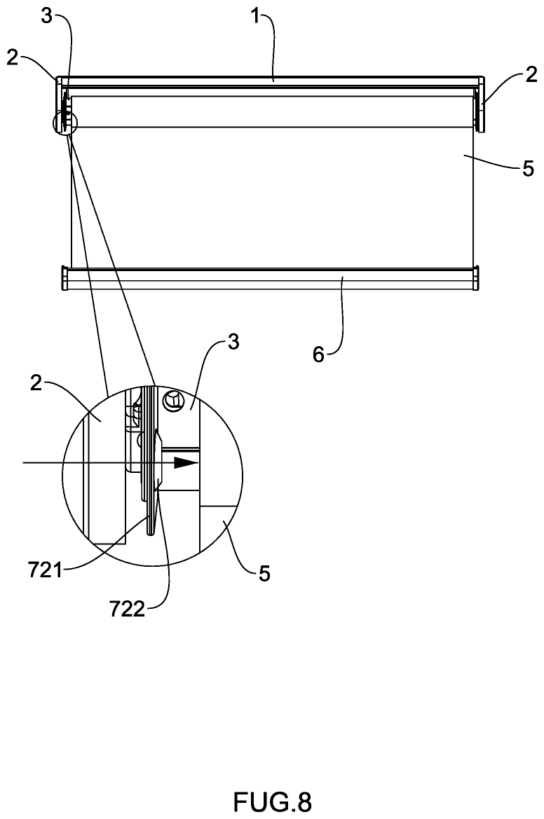

As shown in FIGS. 7 and 8, when the shade 5 moves upward and tilt, the shade 5 moves along the ramp face 721 and the protrusions 722 which correct and guide the shade 5 not to tilt. By the window shade adjustment device of the present invention, the shade 5 does not tilt during moving upward and downward.

While we have shown and described the embodiment in accordance with the present invention, it should be clear to those skilled in the art that further embodiments may be made without departing from the scope of the present invention.

What is claimed is:

1. A window shade adjustment device comprising:
a top rail, two covers connected to two ends of the top rail, a housing located between the two cover and being a hollow tube, a scrolling part located in the housing, the top rail having a slit formed axially along one side thereof, a shade having an insertion on a top edge thereof, the insertion inserted into the slit, the shade being lifted or lowered along with rotation of the housing, a bottom rail connected to a lower end of the shade, and
two end caps respectively engaged with the two ends of the housing, each end cap located between the cover corresponding thereto and the housing, each end cap including a tubular portion and a flange which extends radially outward from the tubular portion, the tubular portion of each end cap inserted into the housing, the end caps being co-rotated with the housing, each of the flanges being a ring-shaped part, a thickness of each of the flanges being reduced from a center of the flange toward a periphery of the flange so as to form a ramp face that faces the housing, multiple protrusions protruding axially from the ramp face of each of the flanges and toward the housing, the protrusions located circularly along the flanges, when the shade moves upward and tilt, the shade moves along the ramp face and the protrusions which guide the shade not to tilt.

2. The window shade adjustment device as claimed in claim 1, wherein the scrolling part is a torsion spring.

3. The window shade adjustment device as claimed in claim 1, wherein the scrolling part is a gear box.

4. The window shade adjustment device as claimed in claim 1, wherein each protrusion is a crescent-shaped protrusion.

5. The window shade adjustment device as claimed in claim 1, wherein an angle between the ramp face and a vertical line is 2 to 8 degrees.
